(19) United States
(12) Patent Application Publication
(10) Pub. No.: US 2010/0280969 A1
(43) Pub. Date: Nov. 4, 2010

(54) Method and system for managing pension portfolios

(75) Inventor: Ronald J. Ryan, Jupiter, FL (US)

Correspondence Address: Joseph Carvalko, 50 Beach Avenue, Milford, CT, 06460, US

(73) Assignee: Ryan IP Holdings LLC

(21) Appl. No.: 12/387,398

(22) Filed: May 1, 2009

(51) Int. Cl. G06Q 40/00

(52) U.S. Cl. 705/36 R

(57) ABSTRACT

The present invention relates to determining and adjusting the funding adequacy of a pension plan by calculating: a custom liability index, an asset allocation model, a performance attribution model; and managing alpha and beta portfolios, including inputting selected data from an actuarial report based upon benefit schedules and plan contributions; and determining if the assets in the alpha portfolio exceed the growth in liabilities; and if the alpha assets exceed the growth of liabilities; then determining if the excess exceeds a threshold; and if the excess are greater than the threshold then transferring the excess according to a predefined percentage, and reducing the assets in the alpha portfolio by an amount transferred; and calculating a performance attribution; and if the performance attribution is less than required to meet the pension plan benefit obligations then choosing new investments or adding cash and calculating an actuarial analysis for the pension plan.

### FIELD OF INVENTION

The invention relates generally to a method and system, as implemented by a software program on a computer system, creating liability indexes, calculating asset allocation, measuring performance attribution and managing alpha and beta portfolios for pension accounts.

### BACKGROUND

A structured asset management portfolio system measures the funding adequacy of a pension plan with an objective to eliminate pension deficits over a target time horizon. In FIG. 1a, a graph 60 illustrates pension assets and pension liabilities as a rolling 12 month return. The value of the pension assets 62 fluctuates above and below the pension liabilities 61. The fluctuation causes a cumulative difference or funding gap over time, which gap has to be managed to bring liabilities in line with assets. As illustrated in FIG. 1b, the graph 63 shows cumulative returns from pension assets portfolio performance 65 consistently below the cumulative pension liabilities 64 over a period of years (1999-2008), which creates a net difference 66, which if left unmanaged, would produce a shortfall in the pension's ability to meet its obligations. Investments to satisfy the pension liabilities generally referred to as the beta portfolio generally consist of bonds. The alpha portfolio investments are for the purpose of achieving pension asset growth superior to liability growth as measured by a custom liability index (“CLI”). and typically consist of portfolios of non-bonds, such as equities. CLI is also a trademark of Ryan ALM, Inc. of New York, N.Y. Each portfolio must be properly managed to provide pension benefits as required under a pension plan, often a defined benefit plan. The prior art method depicted in FIG. 2 consists of two distinct portfolios: a liability beta portfolio 214 and an alpha portfolio 213 having investments therein. The alpha portfolio 213 has as its objective to outgrow pension liabilities or the beta portfolio 214 based on a target excess return referred to coincidentally as alpha utilizing a custom liability index 203 discount rate to measure CLI liability portfolio 211 performance and an asset allocation model 224 that is managed to eliminate the pension deficit over a target time horizon.

An actuarial report 210 drives the current prior art method 150 for managing the alpha and beta portfolios, 214, 213 respectively. The actuarial report 210 estimates the funding requirements of the pension plan over a target horizon using as its primary assumption funds contributed by pension plan members and a projected benefit payment schedule. The actuarial report 210 thereafter provides the data for creating a custom liability index liability portfolio referred to as CLI 211. The CLI 211 portfolio provides the necessary information to create an asset allocation model 224 used to calculate the investment targets for the beta 214 and alpha portfolios 213 as well as the best allocation of funds for the beta and alpha portfolios to reach a fully funded status by the target horizon date. The custom liability index 203 is based upon either a discount rate 212 as provided by one of FASB, PPA, GASB discount rates or US Treasury zero-coupon bonds yield curve referred to as STRIPS. FASB refers to the Federal Accounting Standards Board statement that requires publicly-traded companies in the U.S. to classify their assets based on the certainty with which fair values can be calculated. For example, in the context of pension plans, FAS 158 sets forth the objective of selecting assumed discount rates that measure the single amount that would provide the necessary future cash flows to pay a pension benefit when due. Similarly other standards are promulgated by PPA which refers to funding requirements under the U.S. Pension Protection Act of 2006, and GASB which refers to Governmental Accounting Standards Board, the source of generally accepted accounting principles (GAAP) used by State and Local governments.

Based on the size of the pension deficit and the true economic funded ratio (assets/liabilities) an asset allocation decision would be made as to the most prudent allocation of beta and alpha assets, i.e, alpha assets that have a high probability of meeting the target return on assets or the excess return needed to cure any pension deficit. The objective being that the pension plan becomes a fully funded plan over a time horizon equal to the average duration of a liability schedule as determined by the CLI based upon the actuarial accounting analysis of the pension benefit plan or whatever time horizon best fits the client and their accounting rules.

The CLI 211 provides the necessary calculations for the beta portfolio 214 such that it can match and fund the required projected liability benefit payments of the pension plan. Therefore the beta portfolio represents a liability index fund that neutralizes the interest rate sensitivity of liabilities based on a particular discount rate 212.

The CLI 211 also provides the calculation of critical data on liabilities needed to measure a performance attribution 221 of the combined beta and alpha portfolio performance or each separately and may generate a performance attribution report (“PAR”). PAR is also a trademark of Ryan ALM, Inc. of New York, N.Y. As shown in FIG. 1c, the performance attribution 221 determinations produce a report 70 having in column 1, eight distinct measurements of relative risk 72, four measurements of relative reward 74 and two measurements of relative risk-adjusted returns vs. liabilities 76. In FIG. 1c, the hypothetical pension plan is shown with various risk, reward and relative risk-adjusted returns vs. liabilities depending on measurements according to a standard index, such as the S&P 500 (column 2), as well as a measurement utilizing CLI 211 (column 3).

As the alpha portfolio 213 growth rate exceeds the liability growth rate its excess returns are transferred or ported over 217 to the liability beta portfolio 214, thus shifting the asset allocation dynamically or tactically towards the liability beta portfolio 214. The resulting benefits eventually meet the plan objectives. Through time, the beta portfolio will grow with the goal of fully funding pension liabilities over the target time horizon. The liability beta portfolio 214 reinvests these ported funds chronologically to match the pension plan liabilities.

Beta as used in the process is defined as the single portfolio that matches the liability objective as measured by the CLI with some certainty. BETA is also a trademark of Ryan ALM, Inc. of New York, N.Y. Since most objectives are defined by an index benchmark, the beta portfolio 214 is an index fund by definition. If the pension objective as determined by the actuarial report 210 is liability driven the beta for pensions must be the portfolio that matches the cash flow schedule of pensions. This is better described and managed as a liability index fund. The liability beta portfolio must match each benefit payment; and, it must maintain the same yield curve shape or term structure. Pension plan managers need to know what percentage of the liabilities are due each year. Since contributions and the funded ratio are based on present value calculations it is essential that the liability beta portfolio match the interest rate sensitivity for the liabilities that it is funding. Interest rate sensitivity refers to the change in present value dollars based upon a change in the discount rates. The CLI runs two separate reports that calculate the change of present value dollars based upon a change in the discount rates as a growth rate percentage and as the ending present value.

This requires a CLI 211 to provide the present value weights (term structure) and amounts so the beta portfolio knows how to best model the liability index objective. The CLI 211 provides a daily liability growth calculation for every year of liability payments plus total liabilities so the plan can constantly monitor that the liability beta portfolio is on track (matched portfolio).

A custom index portfolio such as CLI 211 permits shifting to a less risky asset allocation as the funded ratio improves and certainly when a surplus exists. As indicated, the beta portfolio 214 matches and fully funds liabilities chronologically starting with the shortest time-wise liabilities. This moves any deficits to the longer liabilities and extends time for the alpha assets to perform relative to the longer liabilities. Projected contributions are viewed as future assets which are used to reduce liabilities so the liability beta portfolio is funding net liabilities, i.e., after contributions are made.

The prior art system 150 (FIG. 2) provides a series of daily reports or as needed. Based upon any new information or changes in the actuarial projections of future liabilities and contributions will necessitate a revision or rebalancing of the CLI 211 and the beta portfolio. The foregoing is a method illustrated in FIG. 2, except as to the computations, and is largely performed manually. That is steps to adjust outcomes as to proper funding depends largely on manual intervention. However, a need exists to automate at least the process by which the excess returns measured against liabilities occur so that the funds can be automatically transferred or ported from the alpha portfolio 214 to the beta portfolio. Additionally, the present method does not automatically determine whether, based upon a performance attribute report 221, if the mix of investments and cash should be altered to meet a pension plan objective.

### SUMMARY OF THE INVENTION

The present invention relates to a method as implemented on a computer system for providing pension plan evaluation and management for alpha and beta portfolios, comprising: creating a CLI plan that calculates for each pension plan the present value, size, shape, growth and interest rate sensitivity of a liability portfolio based upon projected benefit schedules and plan contributions; choosing a discount rate methodology; creating an asset allocation model that calculates the allocation between liability beta and alpha assets based upon the funded ratio of present value of assets over liabilities that uses the CLI for its present value of liabilities; calculating a performance attribution of one or more asset portfolios in an associated pension plan compared against the CLI; (1) determining if the assets in one of said asset portfolios exceed a target growth of the associated pension plan liabilities as measured by the CLI; and (2) determining if the assets in the asset portfolio exceed the size of pension plan liabilities in the liability portfolio as measured by the CLI and (3) determining the size of the excess alpha assets that are to be transferred over to the beta portfolio based upon the relative growth of the alpha assets versus the determined excess growth needed over liability growth as measured by the growth of the CLI; and transferring the excess assets from the alpha assets portfolios to the beta portfolio; and if the excess assets do not exceed the preassigned threshold of target alpha growth then do not transfer the excess assets; and calculating a performance attribution of asset risk/reward behavior versus the CLI risk/reward behavior.

The present invention relates to a computer system to provide pension plan evaluation and management for alpha and beta portfolios comprising: a server computer, one or more databases, a plurality remote work stations having means for calculating and means for retrieving and storing data in the one or more databases, said server computer, databases and remote work stations operable under one or more operating systems for registering pension plans; inputting selected data from an actuarial report based upon projected benefit schedules and plan contributions; selecting a discount rate; creating a custom liability portfolio; calculating a custom liability index; sorting and comparing like assets and like liabilities in the alpha and beta portfolios for associating like assets and like liabilities; calculating the value of a liability portfolio; calculating the value of the beta and alpha asset portfolios; and (1) determining if the assets in the asset portfolios exceed the liabilities in the custom liability portfolio based on a funding ratio; and (2) determining if the assets in the asset portfolio exceed the size of pension plan liabilities in the liability portfolio as measured by the CLI and (3) determining the size of the excess alpha assets that are to be transferred to the beta portfolio based upon the relative growth of the alpha assets versus the determined excess growth needed versus liability growth target alpha growth as measured by the growth of the CLI; then transferring the excess assets from the alpha assets to the beta portfolio; and if the excess assets do not exceed the preassigned threshold target alpha growth then do not transfer the excess assets; and calculating a performance attribution of asset risk/reward behavior versus the CLI risk/reward behavior

### BRIEF DESCRIPTION OF THE DRAWINGS

Understanding of the present invention will be facilitated by consideration of the following detailed description of the preferred embodiments of the present invention taken in conjunction with the accompanying drawings wherein:

FIGS. 1a, 1b are graphs depicting assets and liabilities of alpha and beta portfolios;

FIG. 1c is an example of a performance attribution report of the prior art;

FIG. 2 is a flow chart of a method for creating liability indexes and managing alpha and beta portfolios according to the prior art;

FIG. 3 is a block diagram of a computer system for creating liability indexes and managing alpha and beta portfolios according to an embodiment of the present invention;

FIG. 4 is a flow chart of a method for creating liability indexes and managing alpha and beta portfolios according to an embodiment of the present invention;

FIG. 5 is a block diagram of a method for creating liability indexes and managing alpha and beta portfolios according to an embodiment of the present invention;

FIG. 6 is a graph of a liability indexes used in managing alpha and beta portfolios according to an embodiment of the present invention.

### DETAILED DESCRIPTION

It is to be understood that the figures and descriptions of the present invention have been simplified to illustrate elements that are relevant for a clear understanding, while eliminating, for the purpose of clarity, many other elements found in computing systems and methods of making computations. Those of ordinary skill in the art may recognize that other elements and/or steps may be desirable in implementing the present invention. However, because such elements and process steps are well known by those of ordinary skill in the art, and because they do not facilitate a better understanding of the present invention, a discussion of such elements and steps is not provided herein.

The following description includes the best mode of carrying out the invention. The detailed description is made for the purpose of illustrating the general principles of the invention and should not be taken in a limiting sense. The scope of the invention is determined by reference to the claims. Each part is assigned, even if structurally identical to another part, a unique reference number wherever that part is shown in the drawing figures.

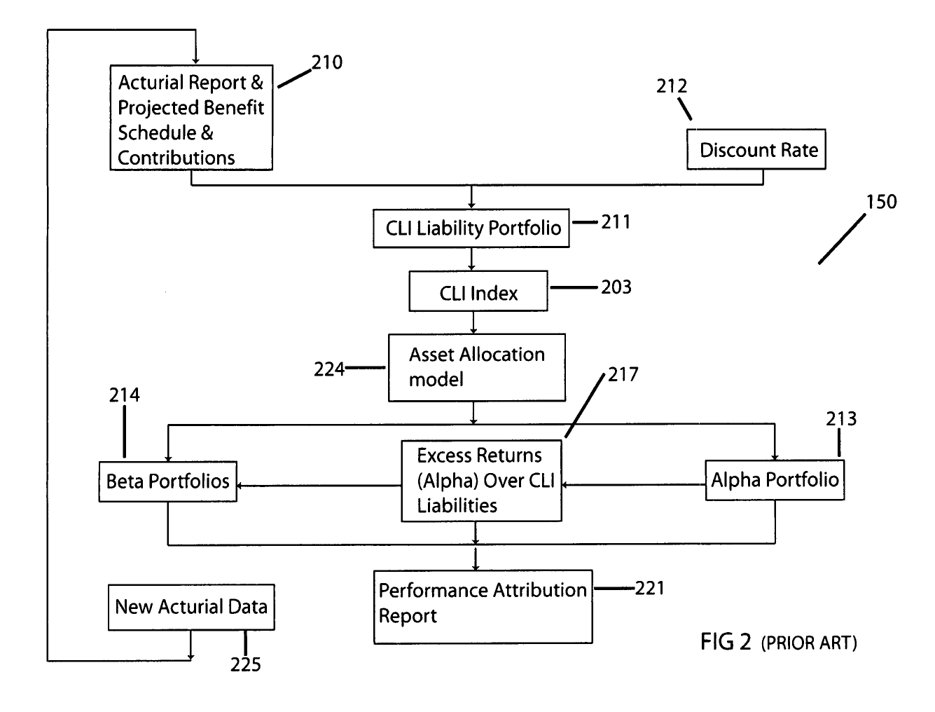

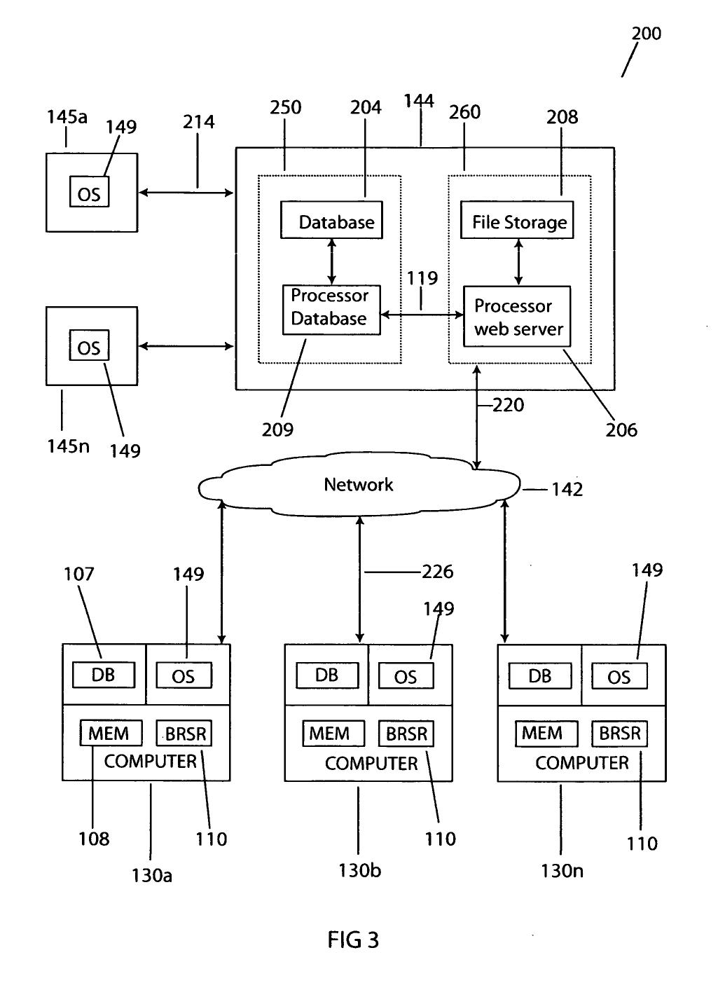

FIG. 3 of the present invention relates to a system 200 for optimizing the relationship between alpha and beta liabilities in a pension portfolio utilizing a distributed web based system, which includes at least one central processing computer 144. Central processing system 144 includes one or more computer sub-systems 250, 260 each with processors 209, 206. Processor 209 is used as a database server that accesses a database 204 and processor 206 is used as a web server that accesses file storage, communicates with processor 209 via channel 119 and provides Internet communication. Central processing system 144 utilizes processor 206 as a web server that optionally communicates over communication channels 214 to one or more work stations 145a-145n, having operating systems 149 that provide ancillary pension management services such as maintaining databases having a discount rate 212 (FIG. 2), as provided by outside sources, for FASB, PPA, GASB discount rates or US Treasury zero-coupon bonds yield curve referred to as STRIPS. These workstations may also provide for portals, through which various funds, equity markets and other investments are accessed for later incorporation into the pension plans.

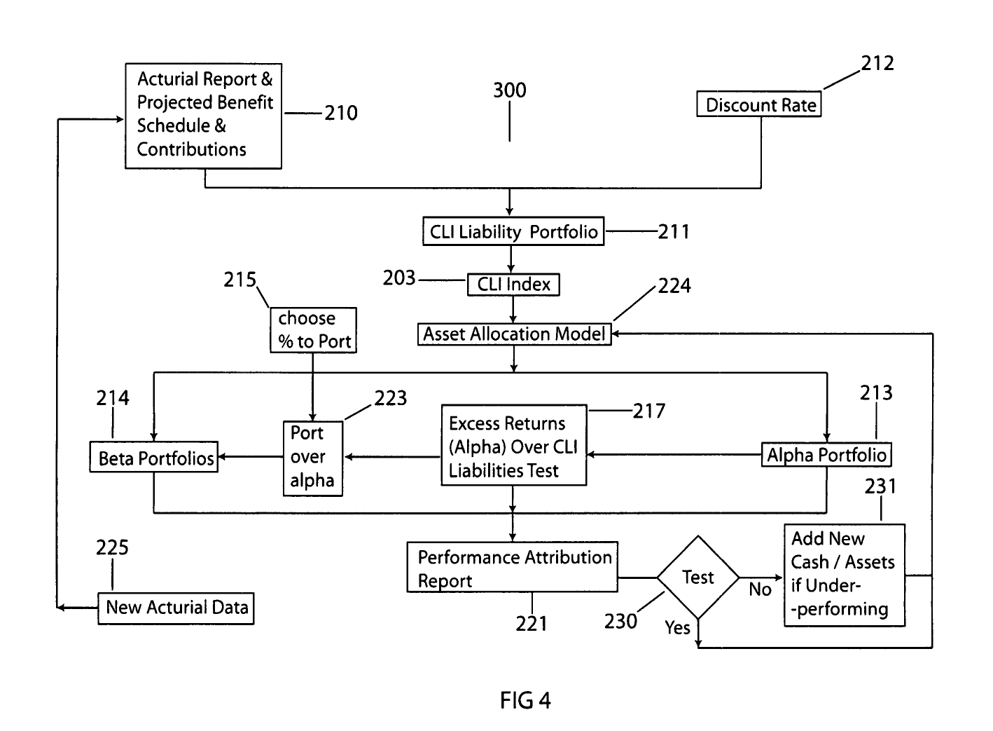

The central processing system 144 maintains web server 206 to communicate over channels 220, 226 via network 142 to one or more user machines 130a to 130n. Each user machine 130a-n contains a memory having an operating system 149, and code for carrying out various functions in connection with embodiments of the invention herein as well as a data base 107 to store data relevant to calculations of beta and alpha portfolios (214, 213 FIG. 4), and having therein various pension plans as well as associated actuarial analyses. It is not necessary that each machine 130a-n or 145a-n is of the same operating system, nor central processing unit (CPU) type. Processors 209, 206 include at least one CPU, at least one communication port or hub, at least one random access memory (RAM), at least one read-only memory (ROM) and one or more databases such as database 204 or data storage devices 208. All of these later elements are in communication with respective CPUs to facilitate the operation of the system 200. The sub-systems 250, 260 may be configured in many different ways. For example, server 206 may be a conventional standalone computer or alternatively, the function of server may be distributed across multiple computing systems and architectures.

The processors 209, 206, remote pension work stations 130a-n and the work stations 145a-n, each include a CPU, such as one or more conventional microprocessors and one or more supplementary co-processors such as math co-processors. Additionally the CPU has means such as an arithmetic logic unit (ALU) for calculating and logical registers for addressing and retrieving and storing data in the one or more databases. The processors are typically in communication with a communication port through which the processor communicates with other devices such as other servers, user terminals or devices. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The processors 209, 206 as well as computers 130a-n and 145a-n, are also in communication with one or more data storage devices. The data storage devices may comprise an appropriate combination of magnetic, optical and/or semiconductor memory, and may include, for example, RAM, ROM, flash drive, an optical disc such as a compact disc and/or a hard disk or drive. The processors and the data storage devices each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wired medium or combination of the foregoing.

The data storage devices such as database 107, 204 and memory 108 may store, for example, (i) a program (e.g., computer program code and/or a computer program product) adapted to direct the processor in accordance with the present invention, and particularly in accordance with the processes described in detail hereinafter; (ii) a database adapted to store information that may be utilized to store information required by the program. The databases include multiple records, each record including fields specific to the present invention such as pension plans, financial objectives, CLI, indexes, performance attribution report data, etc.

The program may be stored, for example, in a compressed, an uncompiled and/or an encrypted format, and may include computer program code. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as alternative steps of invention. The computer program code required to implement the above functions (and the other functions described herein) can be developed by a person of ordinary skill in the art, and is not described in detail herein.

The term “computer-readable medium” as used herein refers to any medium that provides or participates in providing instructions to the processor of the computing device (or any other processor of a device described herein) for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

FIG. 3 more specifically depicts the computer system 200 that provides management for an alpha and a beta portfolios comprising: the central processing computer 144, the one or more databases 204,107, the plurality remote work stations 145a-n and remote pension terminals 130a-n, said system having means for calculating and means for retrieving and storing data in the one or more databases 204,107, said computer 144, databases 204,107 and remote work stations 130a-n, 145a-n operable under one or more operating systems for (a) analyzing pension plans; (b) inputting selected data from an actuarial report based upon projected benefit schedules and plan contributions; (c) selecting a discount rate; (d) creating a custom liability portfolio; (e) calculating a custom liability index (f) sorting and comparing like assets and like liabilities in an alpha and a beta portfolio for associating like assets and like liabilities; (g) calculating the value of a liability portfolio; (h) calculating the value of a beta asset portfolio; and (1) determining if the assets in the asset portfolios exceed the liabilities in the custom liability portfolio based upon a funded ratio as measured by the CLI; and (2) determining if the assets in the asset portfolio exceed the size of pension plan liabilities in the liability portfolio as measured by the CLI and (3) determining the size of the excess alpha assets that are to be ported over to the beta portfolio based upon the relative growth of the alpha assets versus the determined excess growth needed versus liability growth (target alpha growth) as measured by the growth of the custom liability portfolio; then transferring the excess assets from the alpha assets to the beta portfolio; and if the excess assets do not exceed the preassigned threshold (target alpha growth) then do not transfer the excess assets; and calculating a performance attribution of asset risk/reward behavior versus the CLI risk/reward behavior

The term “computer-readable medium” as used herein refers to any medium that provides or participates in providing instructions to the processor of the computing device (or any other processor of a device described herein) for execution. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

The computers 130a-n and 145a-n may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc.).

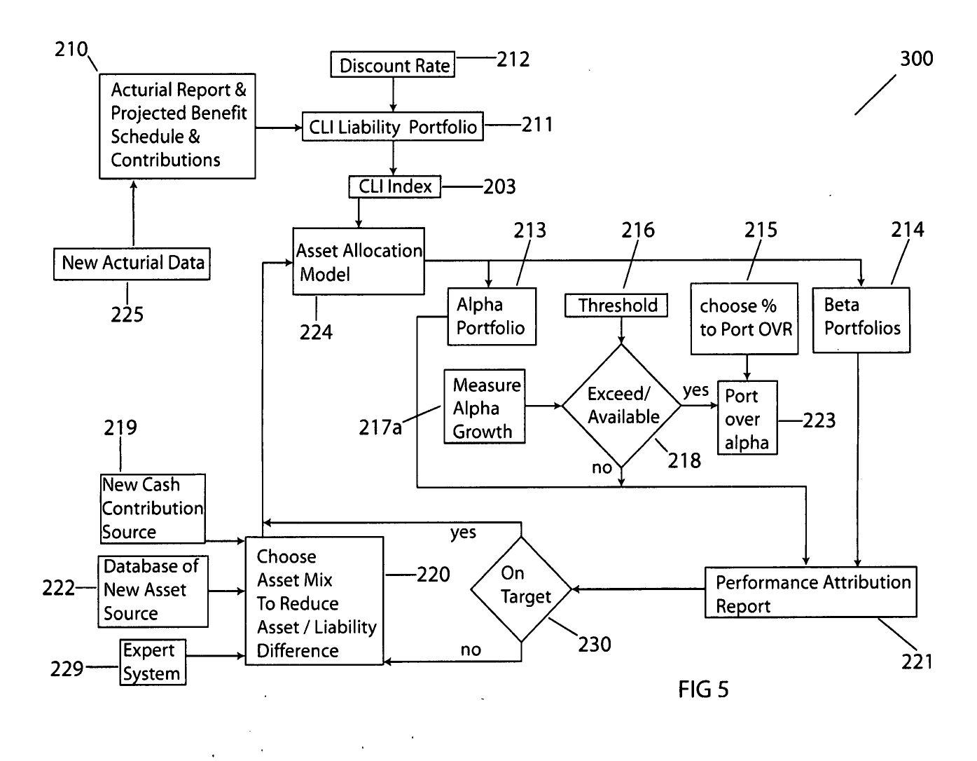

In one embodiment of the invention, each of the computers 130a-n and 145a-n have operating systems 149 such as the Microsoft Windows XP.®., (Microsoft is a trademark of Microsoft, Inc. Redmond, Wash.) Linux.®., Macintosh OSX.®. (Macintosh is a trademark of Apple Computer, Inc.) or any third party operating system. The operating system 149 in each of the computers 130a-n and 145a-n need not be the same as long as it supports web browser 110 or other application program to access the internet and support the execution of codes to facilitate the intended functions of the invention. In another embodiment, compiled Flash VM executable codes of the application such as process 300 (FIG. 5) are downloaded to each of the computers 130a-n from the web server 206 through the network 142 and links 220, 226.

The network 142 and the corresponding links 214, 220 to 226 are part of Wide Area Networks (WAN), Local Area Network (LAN) through Ethernet connections or wireless connections. Yet in other embodiments, the network and the links can be Local Optical Networks (LON) or direct fiber optic links or direct terminal connections or plain old telephone service (POTS). In all forms of link communications within the network 142, the communications can be enhanced with known encryption protocols to improve security.

All services as contained within the web server 206 are equipment selected from the list to include a database server, work station, personal computer, laptop computer, Personal Digital Assistant (PDA), an Intelligent Electronic Device (IED) or any suitable computing platform with sufficient memory and processing power to perform the functions as a web server in a network environment. The user machines 130a-n are equipment selected from the list to include a server, work station, terminal, personal computer, lap top computer, Personal Digital Assistant (PDA), electronic tablet, handheld wireless device, a cellular phone, an Intelligent Electronic Device (IED) or any suitable computing platform with sufficient memory and processing power to perform the functions as a user machine to perform media inputs in a network environment.

In one embodiment, the initialization of the system 200 requires that the computer 130a-n has internet access through link 226 to network 142. A typical configuration will involve the use of a common web browser 110 with a flash plug-in and JavaScript enabled. Through the use of a URL, the user or client makes a request to join a session by sending login credentials to the web server 206. The server 206 in turn will query computer 209 and corresponding database 204 to determine the applications and the current session state parameters that must be downloaded. In addition, plug-ins are optionally downloaded from third party servers as required.

With reference to FIG. 3 and FIG. 4 one embodiment of the present invention utilizes database 204 that contains one or more pension plans, each having individual actuarial report data 210 with associated projected benefit schedules and contributions data. The user of the system 200 and method 300 of the present invention chooses a discount rate 212. The discount rate and the data from the actuarial reports 210 allow the creation of the CLI 211, which is stored in system 200 database 204.

In an alternate embodiment of the present invention, the remote pension terminal 130a-n users have pension plans stored in respective databases 107 and associated individual actuarial reports 210 data with associated projected benefit schedules and contributions data. The user of the system 200 and method of the present invention chooses a discount rate 212, which may be forwarded from the web server 206 to the remote pension terminal 130a-n users accessing its database 204. The discount rate 212 and the data from the actuarial reports 210 allow creation of the CLI 211 which is stored in system 200 database 204 or 107, respectively.

Although, CLI 211 may be calculated on the basis of gross liabilities or net liabilities, in a preferred embodiment of the invention the net liabilities are used since contributions from pensioners and employers is the preferred method to assess fund liabilities. Current assets, especially the beta portfolio 214, in the preferred embodiment, have as an objective funding the net liability in chronological order.

The net CLI 203 with contributions is calculated as follows:

(PB/12)−(PC/12)=NL Equation 1:

NL×MP=MV Equation 2:

(Ending MV/Beginning MV)−1.00×100=GR Equation 3:

Where:
GL=Gross Liability Payments
PB=Projected Benefit Payments
PC=Projected Contributions
NL=Net Liability Payments
MP=Market Price for zero-coupon bond whose maturity=liability payment date
MV=Market Value (GL×MP) or (NL×MP)
Ending MV=End of period (day, month, year)
Beginning MV=MV on date that starts period under review
GR=Growth Rate of Liabilities for certain period

Again in reference to FIG. 3 and FIG. 4, the CLI 211 that is stored in system 200 database 204 and/or 107 is employed to create an asset allocation model 224, where assets are attributed to the alpha portfolio 213 and are attributed to the beta portfolio 214. An accounting of the assets in the alpha portfolio determine if the alpha portfolio has increased in value since the last iteration of calculating the pension assets and liabilities in accordance with the process 300, and whether the alpha returns exceed liability returns and if alpha has increased in sufficient value to transfer excess returns to the beta portfolio, then a percentage of the assets accumulated in the alpha portfolio 213 based upon a pre-assigned value or target alpha 215 are used to compute and transfer 223 a percentage of the alpha assets 213 to the beta portfolio 214.

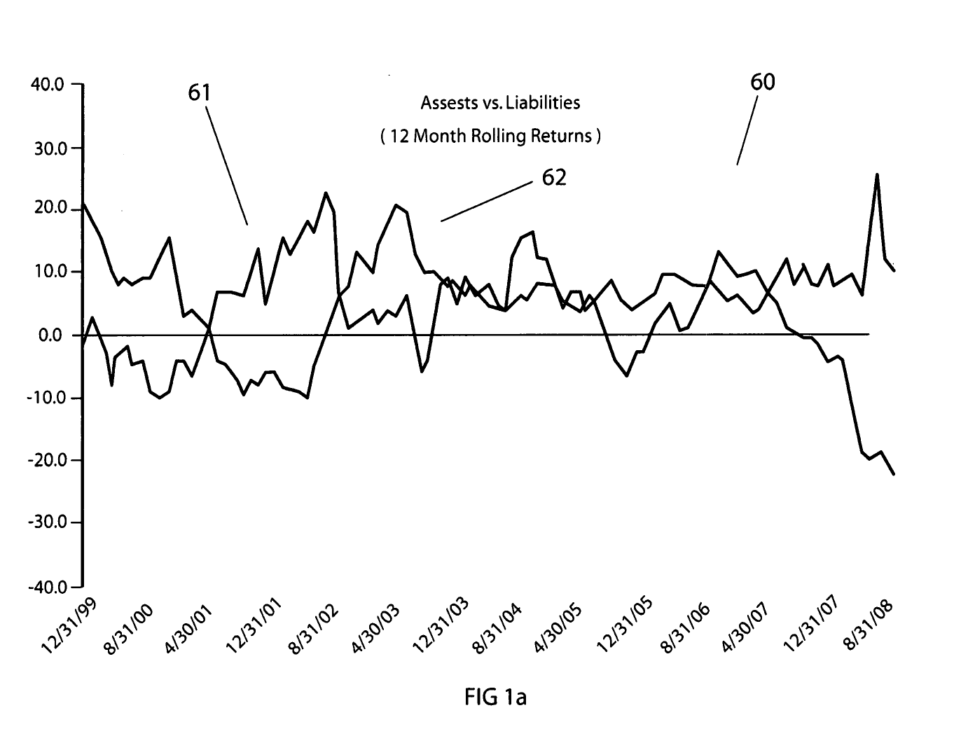

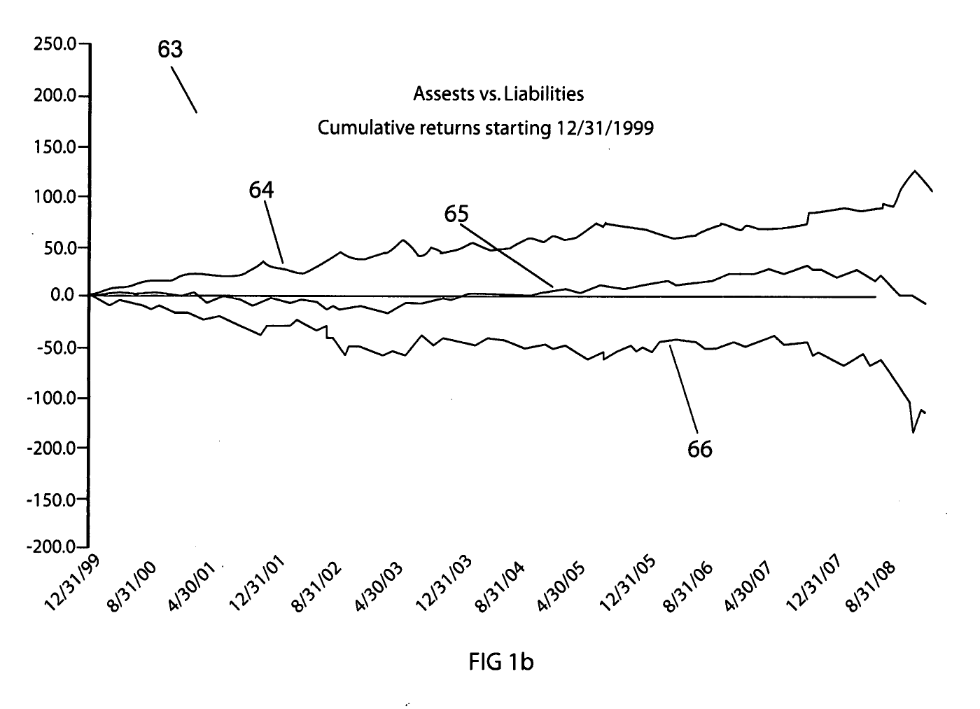

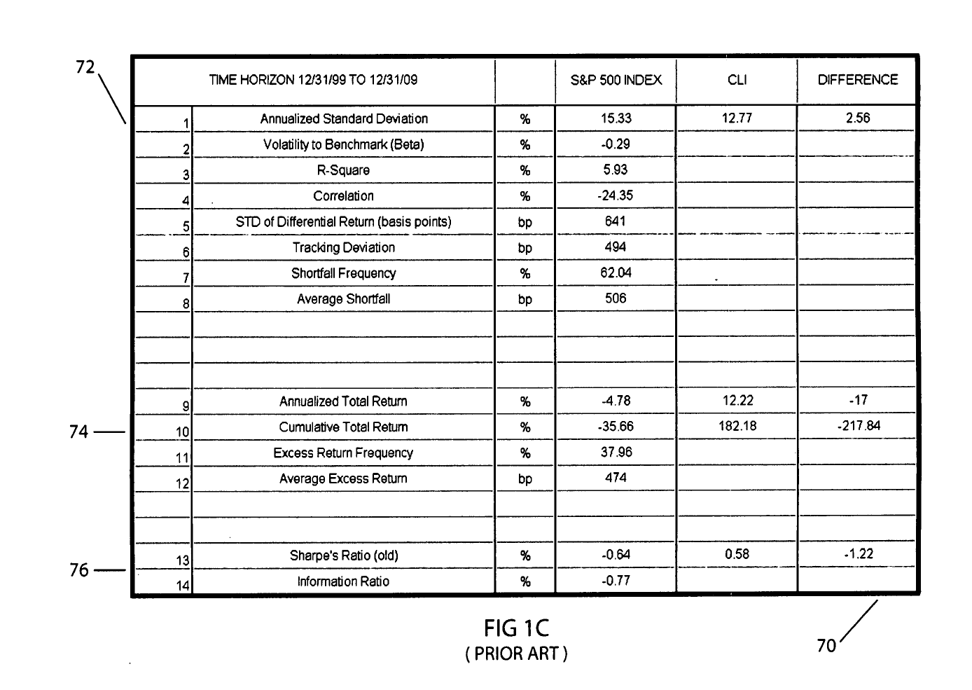

As illustrated in FIG. 4, the beta portfolio 214 and alpha portfolios are analyzed as to performance attribution 221 and whether they are meeting the pension plan objectives according to data is stored in the database 204 or 107. If the performance is not meeting the financial expectations of the pension plan then the user has the option of increasing cash or altering the investments used by the plan to allocate assets between both the alpha portfolios 213 and the beta portfolio 214. Based on the performance of the alpha portfolio 213 and the beta portfolio 214, the performance attribution 221 is calculated as noted with reference to FIG. 1c to produce report 70 having the eight distinct measurements of relative risk 72, four measurements of relative reward 74 and two measurements of relative risk-adjusted returns vs. liabilities 76.

The performance based upon the performance attribution 221 data analysis is input to a function 230 that tests if the performance of the pension plan is meeting the plan's criteria insofar as its obligations to satisfy the pension benefit requirement within the target horizon time period. If the performance is not meeting the expectations of the plan then new cash, other assets, or investment alterations are factored into a new asset allocation model 224. The new cash, other assets, or investments are added to the asset alpha portfolio 213 or the beta portfolio 214 via the new allocation model 224. On a regular interval, new actuarial data 225 is used to generate subsequent actuarial report 210 and corresponding data, which in turn feed into the custom liability index to compute the factors indicated in equations 1, 2 and 3.

FIG. 5 illustrates yet another embodiment of the invention wherein as indicated in FIG. 4, the alpha portfolio 213 and beta portfolio 214 are created on the basis of the allocation model 224 and CLI 211 utilizing a fixed discount rate 212 and the equations 1, 2, and 3. An accounting of the assets in the alpha portfolio includes measuring alpha asset growth in excess of liability growth 217a (FIG. 5) then in function 218 it is determined whether the excess alpha exceeds a preassigned threshold 216. If it exceeds the preassigned threshold 216, then a percentage of the assets accumulated in the alpha portfolio 213 based upon a pre-assigned value 215 are ported over or transferred 223 to the beta portfolio 214 to match and fund more liabilities. If the excess alpha does not exceed a preassigned threshold 216 as determined by function 218 then the process 300 proceeds to calculate the performance attribution 221.

With further reference to FIG. 5, the alpha portfolio 213 data and the beta portfolio 214 data serve as input to the performance attribution report 221. The performance attribution 221 data output in the form of a report is utilized to determine if the pension objectives are being met. In decision block 230, if the performance of the plan is on target the a “yes” indicates to the asset allocation model not to alter the previous assumptions, but use the updated alpha portfolio 213 and beta portfolio 214 data in reforming the alpha portfolio 213 and beta portfolio 214. However, if the decision block 230 determines that the pension plan is not meeting expectations regarding discharging its obligations over a target time horizon or period, then the plan administrator has the option to choose to alter 220 with in infusion of new cash, other assets, or investment alterations, which are then factored into a new asset allocation model 224. It is recognized that the plan administrator may be a virtual administrator whose actions are autonomously directed by an expert software system 229 that determines the mix of cash, other assets, or investment alterations necessary to bring the plan into compliance with its obligations within the target time horizon. U.S. Pat. No. 6,021,397 addresses one such system. The performance attribution 221 data output may optionally provide input to such an expert system for determining the mix of cash, other assets, or investment alterations necessary to bring the plan into compliance with its obligations within the target time horizon. Expert systems that deal with automatic allocation of investment assets are well known by those of ordinary skill in the art of econometrics.

FIG. 3 in conjunction with FIG. 5 illustrate the foregoing process 300 of the present invention for managing alpha and beta portfolios, 214, 213 respectively as implemented on a computer system 200 having installed thereon computer readable code: for inputting selected data from an actuarial report 210 based upon projected benefit schedules and plan contributions; choosing a discount rate 212; creating a custom liability portfolio 211; creating a custom liability index 203 to measure performance of the portfolio 211; allocating like assets and like liabilities 224; calculating the value of liability portfolio 213; calculating the value of asset portfolio 214; (1) determining by measurement 217a if the assets in the asset portfolio exceed the liabilities; and (2) if the assets in the asset portfolio exceed the liabilities in the liability portfolio, then determining if the excess assets are greater than a preassigned threshold 216; and (3) if the excess assets are greater than the preassigned threshold 216 then transferring the excess assets 223 according to a preassigned percentage 215 to the liability portfolio 214, and reducing the assets in the alpha portfolio by an amount transferred; and if the excess assets as determined by measurement 217a do not exceed the preassigned threshold 216 then do not transfer the excess assets, and if the asset portfolio assets 213 do not exceed the liability portfolio 214, then do not reduce the assets in the alpha asset portfolio 213; and calculating a performance attribution 221; and if the performance attribution 221 is less than required to meet the pension plan benefit obligations during a fixed time frame then choosing 220 new investments or adding cash assets to the asset.

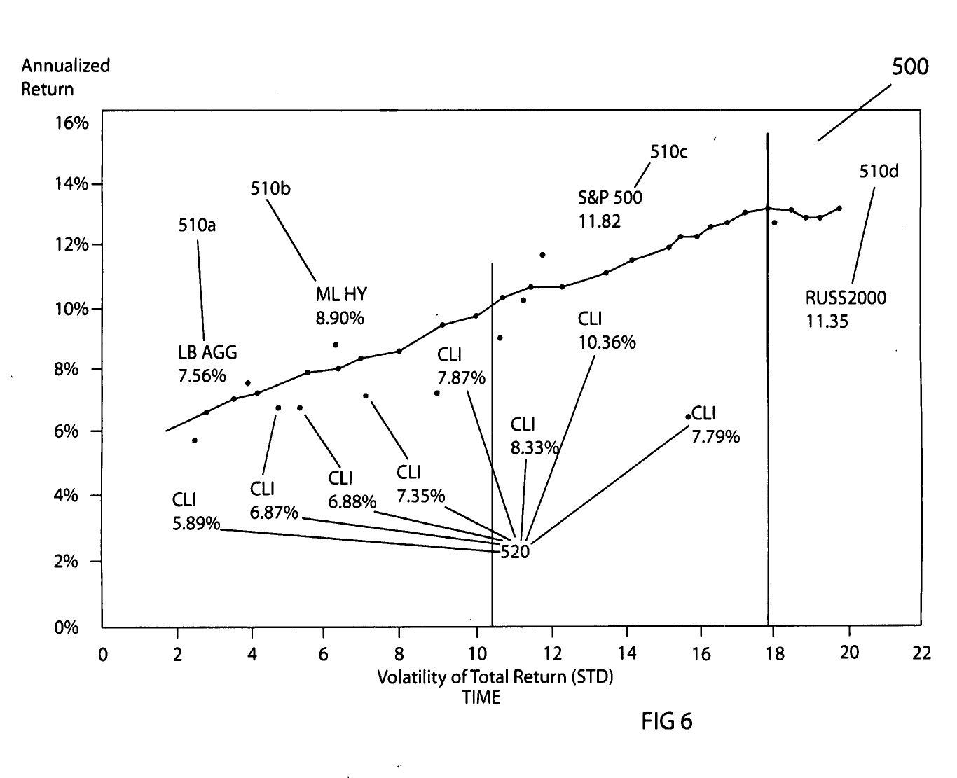

FIG. 6 is a graph of a various liability indexes applied to a hypothetical pension having returns over a 22 year period. The hypothetical pension fund shows an annualized rate of return 500 based upon using several different indices (510a-510d), compared to a liability index 520 represented by STRIPS and annualized return. The CLI 520 illustrates that the returns would be considerably over valued if either one off the different indices (510a-510d) were used. CLI 520 provides a better fit for the actual annualized rate of return, and better illustrates its volatility over the period of 22 years.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

What is claimed is

1. A method as implemented on a computer system for providing pension plan management of alpha and beta portfolios, comprising: inputting selected data from an actuarial report based upon projected benefit schedules and plan contributions; choosing a discount rate; creating a custom liability portfolio; creating a custom liability index to measure the performance of the custom liability portfolio; allocating assets and liabilities; calculating the value of a liability portfolio; calculating the value of a beta asset portfolio; (1) determining if the assets in the beta and alpha portfolios exceed the liabilities; and (2) if the assets in the alpha portfolio exceed the liabilities in the liability portfolio, then determining if the excess assets are greater than a preassigned threshold; and (3) if the excess assets are greater than the preassigned threshold then transferring the excess assets according to a preassigned percentage to the beta portfolio, and reducing the assets in the alpha portfolio by an amount transferred; and if the excess assets do not exceed the preassigned threshold then do not transfer the excess assets, and do not reduce the assets in the alpha asset portfolio, and calculating a performance attribution; and if the performance attribution is less than required to meet the pension plan benefit obligations during a fixed time frame then choosing new investments or adding cash assets to the asset portfolio.

2. The method of claim 1, wherein choosing a discount rate includes one of: FASB, PPA, GASB discount rates or US Treasury zero-coupon bonds.

3. The method of claim 1, wherein creating a custom liability index rate includes calculating one of: gross liabilities or net liabilities.

4. The method of claim 1, further includes inputting data from an actuarial report for the pension plan and using said actuarial plan data as input from the custom liability index.

5. The method of claim 1, further includes a virtual plan administrator that autonomously chooses one of new investments or adding cash assets to the asset portfolio as necessary to bring the pension plan into compliance with its obligations within a target time horizon.

6. A computer system to provide pension plan management for alpha and a beta portfolios comprising: a central computer, one or more databases, a plurality remote work stations having means for calculating and means for retrieving and storing data in the one or more databases, said central computer, databases and remote work stations operable under one or more independent operating systems for registering pension plans; said work stations having programming means for: (a) inputting data from an actuarial report based upon projected benefit schedules and plan contributions; (b) selecting a discount rate; (c) creating a custom liability portfolio; (d) creating a custom liability index to measure the performance of the custom liability portfolio; (e) sorting and comparing assets against liabilities in an alpha and a beta portfolio; calculating the value of a liability portfolio; (f) calculating the value of a beta portfolio; and (g) (1) determining if the assets in the alpha portfolios exceed the liabilities; and (2) if the assets in the alpha portfolio exceed the liabilities in the liability portfolio, then determining if the excess assets are greater than a preassigned threshold; and (3) if the excess assets are greater than the preassigned threshold then transferring the excess assets according to a preassigned percentage to the beta portfolio, and reducing the assets in the alpha portfolios by an amount transferred; and (4) if the excess assets do not exceed the preassigned threshold then do not transfer the excess assets, and do not reduce the assets in the alpha asset portfolio, and calculating a performance attribution; and (6) if the performance attribution is less than required to meet the pension plan benefit obligations during a fixed time frame then choosing new investments or adding cash assets to the asset portfolio.

7. The system of claim 6, further including a means for calculating a custom liability index based upon data from the actuarial report for the pension plan.

8. The system of claim 6, further including a means for calculating a performance attribute report.

9. The system of claim 6, further including a means for calculating and printing a performance attribute report.

10. A computer readable medium for providing pension plan management for alpha and a beta portfolios comprising, comprising: code for storing data related to registering pension plans; code for calculating data from an actuarial report based upon projected benefit schedules and plan contributions; code for choosing a discount rate; code for creating a custom liability portfolio; code for creating a custom liability index; code for allocating like assets and like liabilities; code for calculating the value of a liability portfolio; code for calculating the value of an asset portfolio; code for determining: (1) if the assets in the alpha portfolios exceed the liabilities; and (2) if the assets in the alpha portfolios exceed the liabilities in the liability portfolio, then determining (3) if the excess assets are greater than a preassigned threshold; and (4) if the excess assets are greater than the preassigned threshold then transferring the excess assets according to a preassigned percentage to the beta portfolio, and reducing the assets in the asset portfolio by an amount transferred; and (5) if the excess assets do not exceed the preassigned threshold then not transferring the excess assets, and (6) not reducing the assets in the alpha asset portfolio, and code for calculating a performance attribution; and (7) if the performance attribution is less than required to meet the pension plan benefit obligations during a fixed time frame then code for choosing new investments or adding cash assets to the asset portfolio and code for calculating a new asset allocation for the pension plan.

11. The computer readable medium of claim 10, wherein the code for storing data related to choosing a discount rate includes one of: wherein choosing a discount rate includes one of: FASB, PPA, GASB discount rates or US Treasury zero-coupon bonds.

12. The computer readable medium of claim 10, wherein the code for storing data related to creating a custom liability index rate includes one of: gross liabilities or net liabilities.

13. The computer readable medium of claim 10, further includes a virtual plan administrator that autonomously chooses one of new investments or adding cash assets to the asset portfolio as necessary to bring the pension plan into compliance with its obligations within a target time horizon.

14. A method as implemented on a computer system for providing pension plan management for alpha and beta portfolios comprising: creating a custom liability index that calculates for each pension plan based upon one or more projected benefit schedules and plan contributions; choosing a discount rate methodology; creating a custom liability portfolio; creating an asset allocation model that calculates the allocation between liability beta and alpha assets based upon the funded ratio of present value of assets over liabilities that uses the custom liability index for its present value of liabilities; calculating a performance attribution of one or more asset portfolios in an associated pension plan compared against the custom liability index; (1) determining if the assets in one of said asset portfolios exceed a target growth of the associated pension plan liabilities as measured by the custom liability index; and (2) determining if the assets in the asset portfolio exceed the size of pension plan liabilities in the liability portfolio as measured by the custom liability index and (3) determining the size of the excess alpha assets that are to be transferred over to the beta portfolio based upon the relative growth of the alpha assets versus the determined excess growth needed over liability growth as measured by the growth of the custom liability index; and transferring the excess assets from the alpha assets portfolio to the beta portfolio; and if the excess assets do not exceed the preassigned threshold of target alpha growth then do not transfer the excess assets; and calculating a performance attribution of asset risk/reward behavior versus the custom liability index risk/reward behavior.

15. The method of claim 14, wherein creating a custom liability index rate includes the present value, size, shape, growth and interest rate sensitivity of a liability portfolio.
